(19) United States
(12) Patent Application Publication
(10) Pub. No.: US 2011/0235332 A1
(43) Pub. Date: Sep. 29, 2011

(54) ORNAMENTAL MODULE AND ORNAMENT DEVICE THEREOF

(76) Inventor: Banly Cheung, Hong Kong (CN)

(21) Appl. No.: 12/734,142

(22) PCT Filed: Mar. 24, 2009
(86) PCT No.: PCT/CN2009/070982

§ 371 Date: Jun. 22, 2010

(30) Foreign Application Priority Data
Mar. 4, 2008 (CN) 20081009131222008

(51) Int. Cl. F21V 33/00; A47G 35/00; F15B 21/00

(52) U.S. Cl. 362/253; 428/542.2; 428/364; 428/397; 91/36

(57) ABSTRACT

The present invention discloses an ornament module with a column structure, which comprises a ornament unit provided on the top of the column structure, a mechanical movement unit connecting to the ornament unit and making the ornament unit move, a motivity unit driving the mechanical movement unit, and a motivity control unit connecting to the motivity unit and controlling the operation of the motivity unit. The present invention also discloses an ornament device which comprises two or more ornament modules, a master computer and a distributed control unit. The distributed control unit is connected to the motivity control unit of each ornament module on one end and connected to the master computer on the other end. To implement the ornament module and the ornament device thereof according to the present invention, their ornamental effects give consideration to application of static and dynamic, planar and stereoscopic, day and night, which can be a fixed setting or a mobile setting, and have good practicability.

### FIELD OF THE INVENTION

The present invention relates to ornament appliance, specifically relates to ornament module and ornament device thereof.

### BACKGROUND OF THE INVENTION

Ornament appliance is common item in modern society, a variety of temporary or fixed-set ornament appliances often can be seen in the exhibition, commercial plaza, gymnasium or the like.

Existing ornament appliances, such as sculptures or the like, which only have a static stereoscopic visual effect, and, when at night, their ornamental effect will be very limited in the absence of illumination.

Existing ornament appliances, such as spotlights or the like, which can be brought into play a static or dynamic lighting ornamental effect at night or in weak light environments, but have a limited role in the daytime.

Existing ornament appliances, such as LCD or LED display, which have planar ornamental effect of playing video, but are lack of ornamental effect of dynamic motion and stereoscopic vision.

Existing ornament appliances, such as musical fountain or the like, which can achieve the ornamental effect of dynamic motion and stereoscopic vision, and, which are supplemented by the lighting ornaments such as spotlights so that around-the-clock ornamental effect can be achieved, however, these ornament appliances can only be fixedly set, and not be moved to other places for use, so the costs of application are higher.

### SUMMARY OF THE INVENTION

The aim of the present invention is to solve the problems in the prior art about that the ornament appliances give no consideration to the static and dynamic effects, the planar vision and the stereoscopic vision, application for day and night, as well as fixed settings and mobile settings, and to provide a new type of ornament module and an ornament device composed of a number of ornament modules.

The ornament module of the present invention is implemented as follows:

An ornament module with a column structure, comprises a ornament unit provided on the top of the column structure, a mechanical movement unit connecting to the ornament unit and making the ornament unit move, a motivity unit driving the mechanical movement unit, and a motivity control unit connecting to the motivity unit and controlling the operation of the motivity unit.

Preferred embodiment is that said ornament unit is high-power LED lamp, incandescent lamp or energy-saving lamp, or, the combination of foregoing lamp and physical ornament.

Preferred embodiment is that the surface of said physical ornament perpendicular to the axial direction of said column ornament module can be square, hexagonal or circular.

Preferred embodiment is that said ornament unit is LED display module.

Preferred embodiment is that said ornament module is provided with display control unit.

Preferred embodiment is that said ornament module includes two or more mechanical movement unit connected actively with said ornament unit respectively.

Preferred embodiment is that said mechanical movement unit with a cylinder-type structure, includes a hollow columnar shell, a hollow base set within the shell cavity, as well as a transmission screw connecting fixedly to the top of said shell cavity and extending into the hollow space of said base along the axial direction of said columnar shell. Said ornament unit is provided on the top of said columnar shell, said motivity unit is a linear motor set fixedly within the hollow space of said base and screwed to said transmission screw, said motivity control unit is a frequency converter.

Preferred embodiment is that said mechanical movement unit with a cylinder-type structure, includes a hollow columnar shell, a hollow base set within the shell cavity, as well as a transmission thread insert connecting fixedly to the top of said shell cavity and extending into the hollow space of said base along the axial direction of said columnar shell, said ornament unit is provided on the top of said columnar shell, said motivity unit is a drive motor set fixedly within the hollow space of said base, said drive motor has a transmission screw screwed to said transmission thread insert, said motivity control unit is a frequency converter.

Preferred embodiment is that said mechanical movement unit with a cylinder-type structure, includes a hollow columnar shell, a hollow base set within the shell cavity, as well as a pressure uplift device set within the hollow space of said base, the top of said pressure uplift device is against the top of said shell cavity closely, the bottom of said pressure uplift device is against the bottom of the hollow space of said base, said ornament unit is provided on the top of said columnar shell, said motivity unit is a pneumatic engine set at the external of said mechanical movement unit for supplying said pressure uplift device, said motivity control unit is a electronically controlled pneumatic valve.

The ornament device of the present invention is implemented as follows:

An ornament device comprises two or more ornament modules, a master computer and distributed control units. Said distributed control units are connected to the motivity control unit of each ornament module on one end and connected to the master computer on the other end.

Preferred embodiment is that said ornament device includes data distributors, said data distributors are connected to each motivity control unit on one end and connected to the master computer on the other end.

Preferred embodiment is that said distributed control unit is a multi-path variable frequency signal generator.

To implement the ornament module and the ornament device thereof according to the present invention, ornament module in static state, especially the ornament device comprising a plurality of ornament modules, can be arranged in different three-dimensional shapes to achieve static visual effect, or, to start motivity unit, each ornament module will make a telescopic mechanical movement individually under the control of the mater computer, as a result, a plurality of ornament units provided on the top of the ornament module will form a three-dimensional moving surface to achieve a dynamic three-dimensional visual effect. If the ornament units are LED display modules and are supplemented by a display control unit, then said three-dimensional moving surface can also play text and video simultaneously. As ornament units can be the combination of illuminants such as physical ornaments and high-power LED lights, so they can be applied day and night. And, if used with display control unit, you can also control the illuminants to be on or off, or control the gradient of light brightness and so on, further enhance the ornamental effect of the ornament device according to the present invention. A single ornament module, as well as ornament device composed of a plurality of ornament modules, not only can be mounted on the places needing to ornament, but also be moved to other places to use after dismounted, practical efficiency is better.

### BRIEF DESCRIPTION OF THE DRAWINGS

FIG. 1 is a basic structural schematic view of ornament module,

FIG. 2 is a structural schematic view of an embodiment of ornament module,

FIG. 3A is a top schematic view of ornamental plane of ornament device arrayed by one hundred ornament modules,

FIG. 3B is a side schematic view of FIG. 3A,

FIG. 4 is a control-flow schematic view of ornament device arrayed by a few of ornament modules,

FIG. 5 is a control-flow schematic view of ornament device arrayed by a lot of ornament modules,

FIG. 6A is a side schematic view and a top schematic view of ornament device composed of a plurality of ornament modules with ornament unit of square surface,

FIG. 6B is a side schematic view and a top schematic view of ornament device composed of a plurality of ornament modules with ornament unit of hexagonal surface,

FIG. 6C is a side schematic view and a top schematic view of ornament device composed of a plurality of ornament modules with ornament unit of hexagonal surface,

FIG. 7 is a structural schematic view of another embodiment of ornament module,

FIG. 8 is a structural schematic view of another embodiment of ornament module,

FIG. 9 is a control-flow schematic view of ornament device arrayed by a lot of ornament modules,

FIG. 10A is a structural schematic view of another embodiment of ornament module,

FIG. 10B is a schematic view of motion state of FIG. 10A.

### DETAILED DESCRIPTION OF THE INVENTION

In the following, the ornament module and the ornament device thereof according to the present invention will be described in further detail with reference to the accompanying drawings and embodiments.

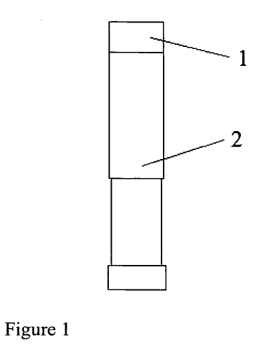

As shown in FIG. 1, an ornament module with a column structure according to the present invention, comprises a ornament unit 1 provided on the top of the column structure, a mechanical movement unit 2 connecting to the ornament unit and making, the ornament unit move, a motivity unit (not shown in the figure) driving the mechanical movement unit, and a motivity control unit (not shown in the figure) connecting to the motivity unit and controlling the operation of the motivity unit.

### Embodiment One

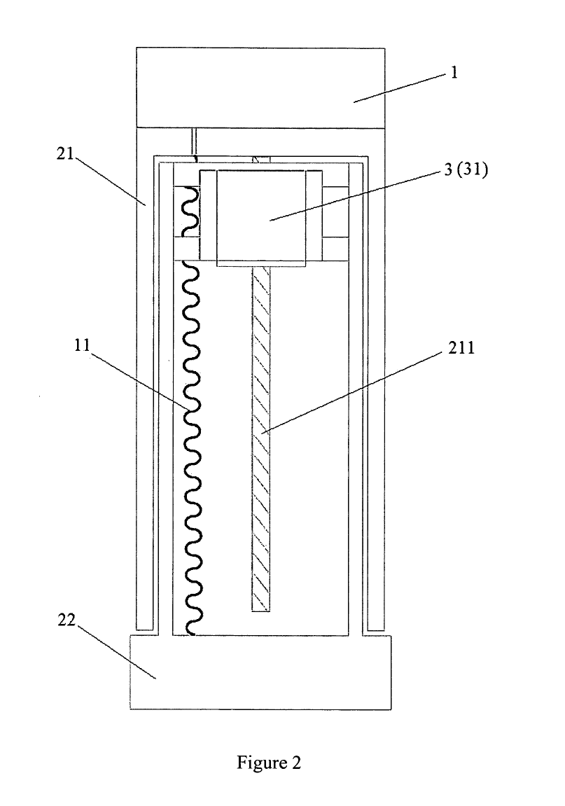

As shown in FIG. 2, the mechanical movement unit of the ornament module with a cylinder-type structure, includes a hollow columnar shell 21, a hollow base 22 set within the shell cavity, as well as a transmission screw 221 connecting fixedly to the top of the shell cavity and extending into the hollow space of the base along the axial direction of the columnar shell, the shell 21 can move up or down mechanically along the base 22, this mechanical movement is started by a motivity unit 3, the motivity unit 3 is a linear motor 33 set fixedly within the hollow space of the base and screwed to the transmission screw 211, then when the motor is forward or reverse, it will drive the transmission screw 211 to move up or down telescopically, and the transmission screw drive the shell to move up or down mechanically along the base. If the motivity control unit is a frequency converter that will further control the speed of the motor, the shell 21 make a up or down motion along the base 22, the motion will be a motion controlled by the variable frequency signals of the frequency converter, not only the direction of the up or down motion, but also the speed have been controlled. So, the ornament module with a column structure according to the present forms into a ornament device which can be controlled by the variable frequency signal and make a corresponding mechanical telescopic motion.

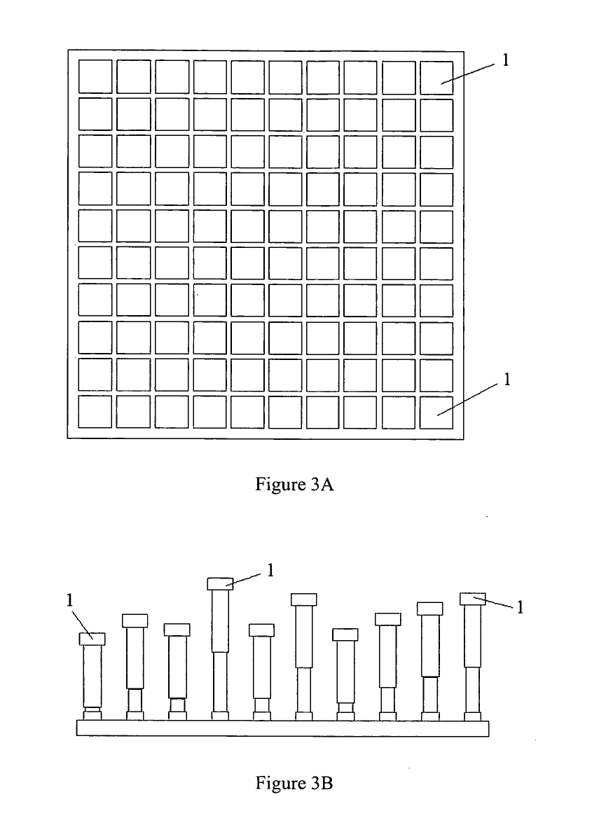

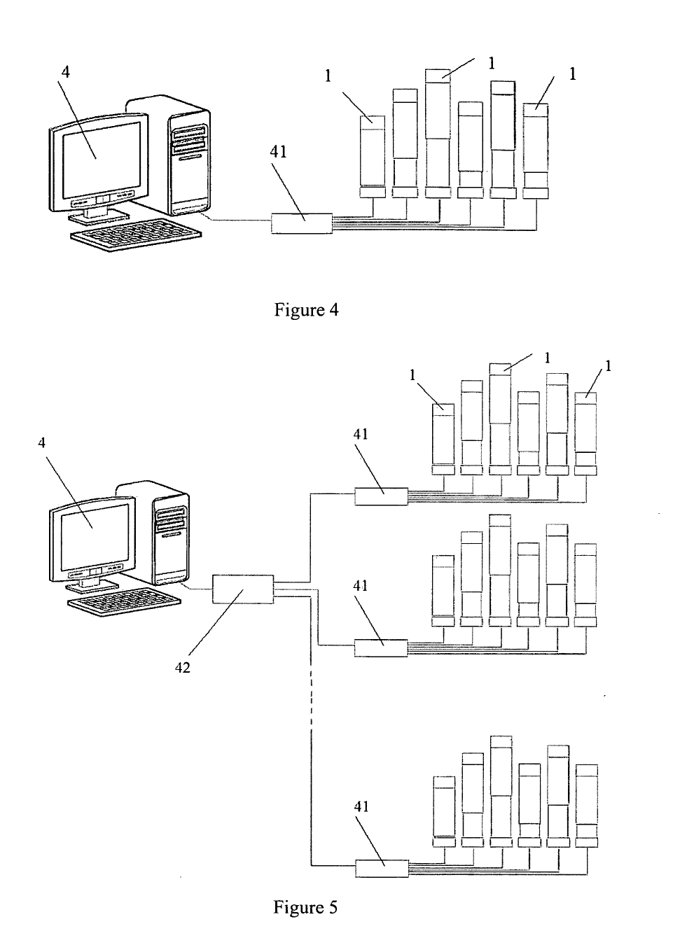

As shown in FIG. 2, the ornament unit 1 is provided on the top of the columnar shell 21 and has an cable 11 integrated with data and power through the top of the columnar shell 21 to connect with the ornament unit 1. If two or more said ornament modules are arranged together in closer distance, then the ornamental plane of this ornament device can be composed of the two or more ornament modules. As shown in FIG. 3A, an embodiment according to the present invention, one ornament device is composed of one hundred ornament modules arranged together in closer distance, then the one hundred ornament units constitutes a ornamental plane. If it is supplemented by a distributed control unit generating variable frequency signal, namely, the distributed control unit is multi-path variable frequency signal generator, then each ornament module connected with the distributed control unit can make up or down mechanical telescopic movement according to its received variable frequency signal independently, thus the ornamental plane of said ornament device can achieve the ornamental effects such as irregular convex movement or regular undulating movement, as shown in FIG. 3B. A master computer which set background make the ornamental plane of the ornament device to achieve these dynamic ornamental effects, its work flow is shown in FIG. 4, first of all, the program of the master computer 4 generates independent movement command of each ornament module to the distributed control units 41. Secondly, the distributed control units generate the corresponding variable frequency signals to the motivity control unit of each ornament module, that is, frequency converter (not shown in the figure). Again, the linear motor of each ornament module is controlled by the frequency converter to provide corresponding dynamic of rotational direction and rotational speed. Driven by the transmission screw, the dynamic controlled by the program of the master computer finally achieve the dynamic movement effects of the ornamental plane composed of ornament units of a plurality of ornament modules.

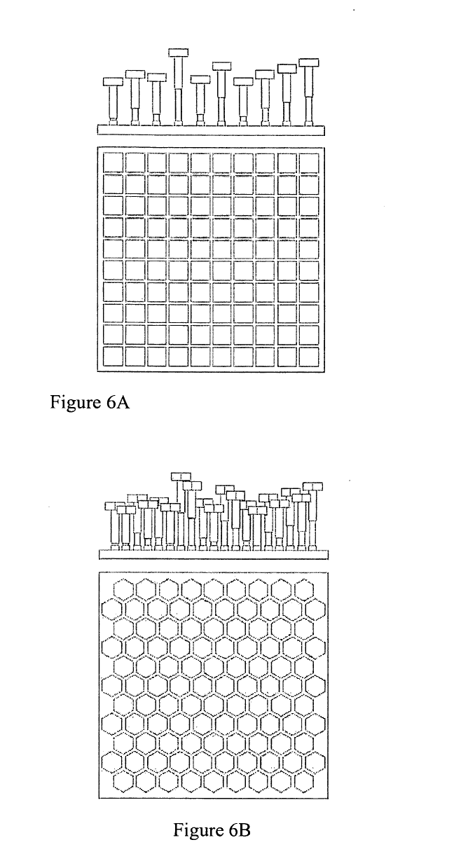

As shown in FIG. 3A, one embodiment of the present invention, one ornamental plane of the ornament device according to the present invention is composed of one hundred ornament modules arranged together in closer distance. In this case, because the control of one hundred ornament units is relatively complex, so based on FIG. 4, as shown in FIG. 5, the data distributors 42 are also set between the master computer 4 and the distributed control units 41. The data distributors 42 generate movement control command to the distributed control units 41, then each distributed control unit 41 manage the ornament module connected with them respectively, for example, A line of ten ornament modules shown in FIG. 3A are managed by one control unit.

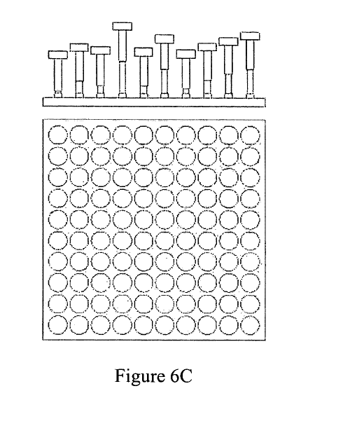

In one preferred embodiment of the present invention, the ornament unit 1 is luminary such as high-power LED lamp, incandescent lamp or energy-saving lamp, then under the control of a program of the master computer, it can make up or down or fast or slow mechanical telescopic movement, which becomes a lighting ornament device with mechanical dynamic effects, or, the ornament unit is the combination of foregoing lamp and physical ornaments, for example, the luminary is set within the central of the physical ornaments, and these physical ornaments have surface with square, hexagonal or circular shape perpendicular to the axial direction of said column ornament module, as shown in FIGS. 6A, 6B and 6C, then even under the conditions that ambient light is strong, for example, in the daytime, the ornamental plane composed of a plurality of ornament modules according to the present invention can achieve the dynamic visual effects. So ornament module and ornament device thereof according to the present invention can be applied around-the-clock to be brought into play its novel ornamental effect. In one preferred embodiment according to the present invention, said luminaries also connect to the display control unit, for example, the display control unit can be a switch control circuit or a brightness adjustment circuit, or a display control unit controlled by program of the master computer, then, ornament module and ornament device thereof according to the present invention can be also further brought into play ornamental effects of illumination variations. If the display control unit here and the aforementioned program of the master computer controlling the mechanical movement of each module are combined, it can further realize the synchronization of mechanical motion and illumination variations, which is very dynamic, the ornamental effects will be further improved.

Another preferred embodiment in the present invention, said ornament unit is a LED display module. The LED display module is a common standard part in LED market, under the control of the display control unit, its multiple combinations can constitute a LED image display. As mentioned above and shown in FIGS. 6A, 6B and 6C, the ornamental plane of the ornament device is formed of a plurality of ornament modules arranged together in closer distance, which becomes an image display. Based on the dynamic visual effects achieved by the mechanical motion of the ornament module, there is added the effects of image displaying or video playing. If the display control unit here and the aforementioned program of the master computer controlling the mechanical movement of each module are combined, can further realize the synchronization of mechanical motion and video playing, which is very dynamic, the ornamental effects will be further improved.

### Embodiment Two

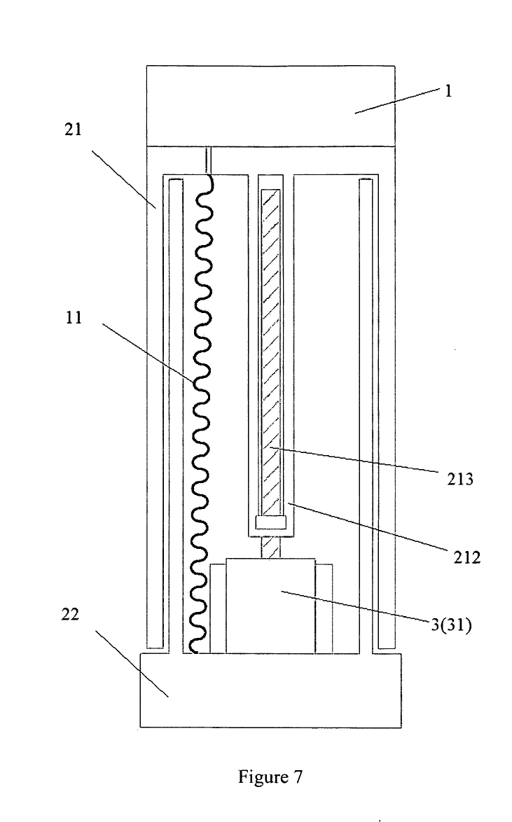

As FIG. 7 shows, the mechanical movement unit of the ornament module with a cylinder-type structure, includes a hollow columnar shell 21, a hollow base 22 set within the shell cavity, as well as a transmission thread insert 212 connecting fixedly to the top of said shell cavity and extending into the hollow space of said base along the axial direction of said columnar shell, the shell 21 can move up or down mechanically along the base 22, the mechanical movement is started by the motivity unit 3, the motivity unit 3 is a rotating motor 31 set fixedly within the hollow space of the base, the rotating motor 31 is connected fixedly with a transmission screw 212 screwed to the transmission thread insert 212, then when the motor is forward or reverse, it will drive the transmission screw 213 to rotate, and the transmission screw drive the transmission thread insert 212 to move up or down telescopically, namely the shell move up or down mechanically along the base. If the motivity control unit is a frequency converter that will further control the speed of the motor, the shell 21 make a up or down motion along the base 22, the motion will be a motion controlled by the variable frequency signals of the frequency converter, not only the direction of the up or down motion, but also the speed have been controlled. So the ornament module with a column structure according to the present forms into a ornament device which can be controlled by the variable frequency signal and make a corresponding mechanical telescopic motion. As shown in FIG. 7, the ornament unit 1 is provided on the top of the columnar shell 21 and has an cable 11 integrated with data and power through the top of the columnar shell 21 to connect with the ornament unit 1.

Obviously, this embodiment can be the same as embodiment one: (1) Two or more ornament modules in the embodiment are arranged together in closer distance to form one large-scale ornament device, so as to form one large-scale ornamental plane. (2) Supplemented by the distributed control units which can generate variable frequency signal, namely, the distributed control unit is a multi-path variable frequency signal generator, then each ornament module connected with the distributed control units can make up or down telescopic mechanical movement according to its received variable frequency signal independently, thus, the ornamental plane of said ornament device can achieve the ornamental effects such as irregular convex movement or regular undulating movement, as shown in FIG. 3B. (3) Using the master computer and the distributed control unit, or further using the data distributors to programmed control ornament device composed of a plurality of ornament modules, shown in FIG. 4 and FIG. 5. (4) Using luminary such as high-power LED lamp, incandescent lamp or energy-saving lamp as ornament unit, or, using said luminaries set within the central of the physical ornaments as ornament unit, and these physical ornaments have surface with square, hexagonal or circular shape, as shown in FIGS. 6A, 6B and 6C, it can be applied around-the-clock to achieve the dynamic visual effects of mechanical motion and illumination variations. (5) Using LED display module as ornament unit to achieve the dynamic effects of mechanical motion and video display.

### Embodiment Three

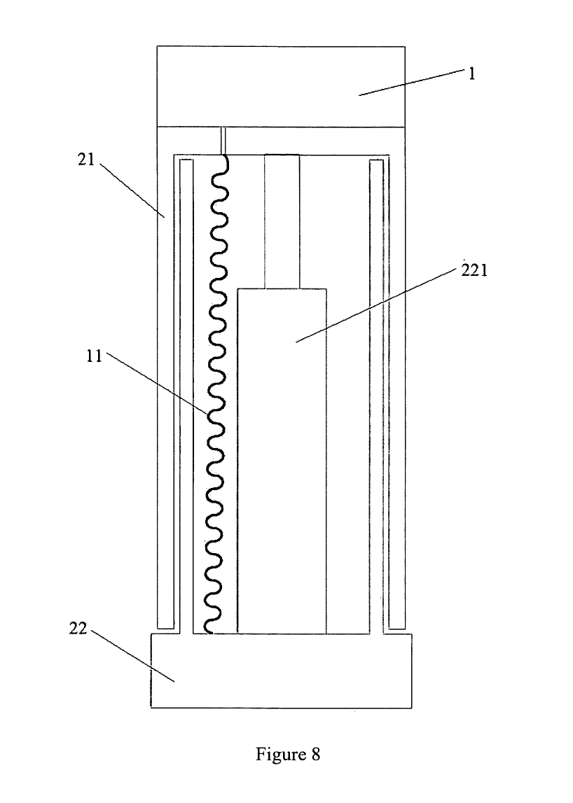

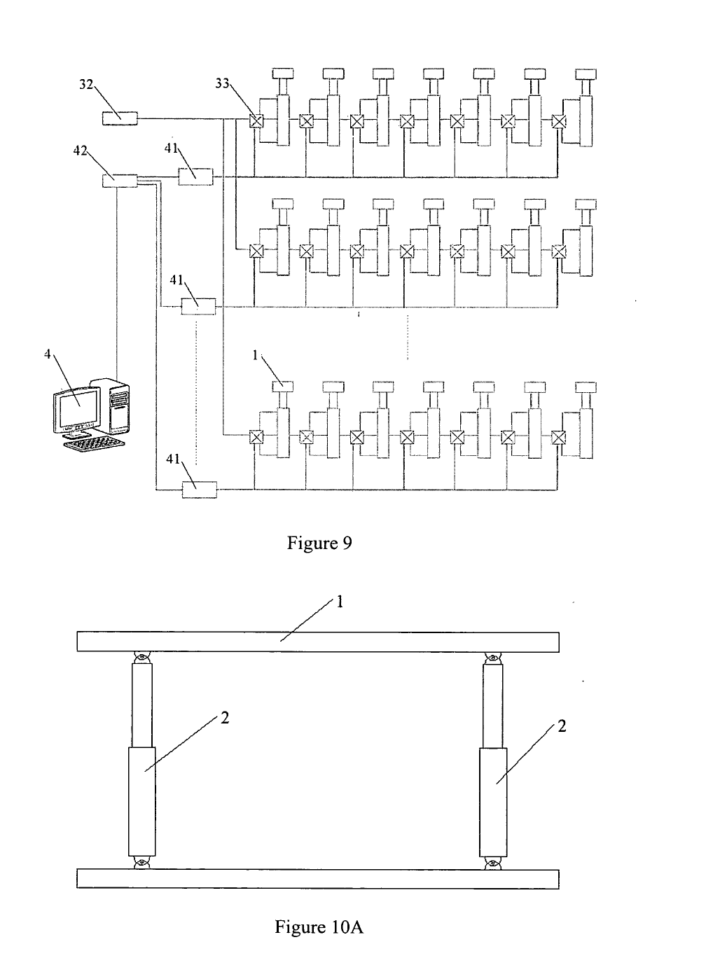

As shown in FIG. 8, the mechanical movement unit of the ornament module with a cylinder-type structure, includes a hollow columnar shell 21, a hollow base 22 set within the shell cavity, as well as a pressure uplift device 221 set within the hollow space of said base. The shell 21 can move up or down mechanically along the base 22. The top of said pressure uplift device 221 is against the top of said shell 21 cavity closely, the bottom of said pressure uplift device 221 is against the bottom of the hollow space of said base 22, the ornament unit 1 is provided on the top of said columnar shell 21, the motivity unit is a pneumatic engine 32 (shown in FIG. 9) set at the external of mechanical movement unit for supplying said pressure uplift device. As shown in FIG. 8, there is a cable 11 integrated with data and power through the top end of the columnar shell 21 to connect with the ornament unit 1. As shown in FIG. 9, as a motivity control unit, an electronically controlled pneumatic valve is connected to the motivity units on one end and connected to the pressure uplift device on the other end, namely, the electronically controlled pneumatic valve controls the pneumatic engine to supply (positive pressure) or suction (negative pressure) the pressure uplift device, and controls the strength of supply or suction so that the ornament module make up or down motion, and controls the speed of its up or down motion. The program of the master computer 4 generates independent movement command to the distributed control unit 41 and the electronically controlled pneumatic valve acts on the command. As shown in FIG. 3A, an embodiment of the present invention, one ornamental plane of the ornament device according to the present invention is composed of one hundred ornament modules arranged together in closer distance. In this case, because the control for one hundred ornament units is relatively complex, so, as shown in FIG. 9, the data distributors 42 are also set between the master computer 4 and the distributed control unit 41. The data distributors 42 generate movement control command to the distributed control units 41, then each distributed control unit 41 generates working command respectively to each electronically controlled pneumatic valve 33 connected with ornament module, so as to realize the motion control and management of all ornament module. For example, a line of ten ornament modules shown in FIG. 3A are managed by one control unit.

Obviously, this embodiment can be the same as embodiment one: (1) Two or more ornament modules in the embodiment are arranged together in closer distance to form one large-scale ornament device, so as to form one large-scale ornamental plane. (2) Supplemented by the distributed control units which can generate variable frequency signals, namely, the distributed control unit is a multi-path variable frequency signal generator, then each electronically controlled pneumatic valve connected with the distributed control units can control the pressure of the pressure uplift device supplied by the pneumatic engine independently according to its received variable frequency signal, so allow the ornament module to make up or down telescopic mechanical movement, thus, the ornamental plane of said ornament device can achieve the ornamental effects such as irregular convex movement or regular undulating movement, as shown in FIG. 3B. (3) Using the master computer and the distributed control unit, or further using the data distributors to programmed control ornament device composed of a plurality of ornament module, shown in FIG. 4 and FIG. 5. (4) Using luminary such as high-power LED lamp, incandescent lamp or energy-saving lamp as ornament unit, or, using said luminary set within the central of the physical ornaments as ornament unit, and these physical ornaments have surface with square, hexagonal or round shape, as shown in FIGS. 6A, 6B and 6C, it can be applied around-the-clock to achieve the dynamic visual effects of mechanical motion and illumination variations. (5) Using LED display module as ornament unit to achieve the dynamic effects of mechanical motion and video display.

### Embodiment Four

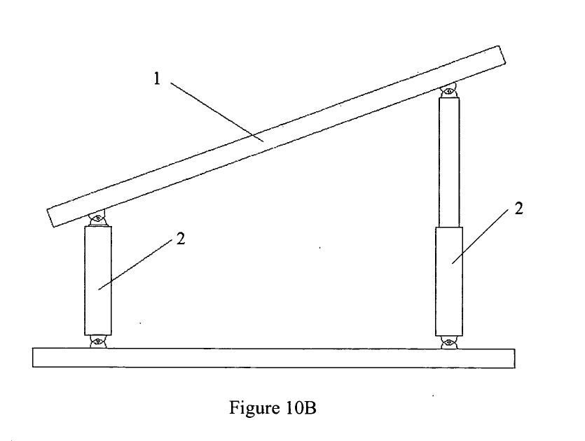

As shown in FIG. 10A, a preferred embodiment according to the present invention is that the ornament module comprises two mechanical movement units 2 connecting actively to the ornament unit 2, namely, one ornament module provides the ornament unit 1 connecting actively to the top of the two mechanical movement units with mechanical motion by two mechanical movement units 2. As shown in FIG. 10B, Compared to the previous embodiment, this ornament module structure not only can make the ornament units to make up or down telescopic mechanical movement at different speeds, but also can make the additional mechanical movement of self-tilting at different speeds. For independent control for each mechanical movement unit, only need to additionally add one distributed control unit (under the case of embodiment one and embodiment two) or electronically controlled pneumatic valve (under the case of embodiment three). If the ornament module comprises two or more mechanical movement units connecting actively to the ornament unit respectively, its principle is the same as the foregoing principle. Obviously, the ornament device composed of a plurality of ornament modules with this structure, the visual effects of its ornamental plane will be further enriched.

From all these embodiments we can clearly see that the ornament module and the ornament device thereof according to the present invention can be moved to other places to use after dismounted, does not always require a fixed set.

In general, the several implementations described in the embodiments above mentioned, do not mean all the implementations of the present invention, these embodiments above mentioned do not limited the present invention, all the structures similar to the technical solutions of the present invention should be within the protection scope of the present invention.

1. An ornament module with a column structure, characterized in that it comprises a ornament unit provided on the top of the column structure, a mechanical movement unit connecting to the ornament unit and making the ornament unit move, a motivity unit driving the mechanical movement unit, and a motivity control unit connecting to the motivity unit and controlling the operation of the motivity unit.

2. An ornament module according to claim 1, characterized in that said ornament unit is high-power LED lamp, incandescent lamp or energy-saving lamp, or is the combination of foregoing lamps with physical ornaments.

3. An ornament module according to claim 1, characterized in that the surface of said physical ornaments perpendicular to the axial direction of said column ornament module can be square, hexagonal, round.

4. An ornament module according to claim 1, characterized in that said ornament unit is LED display module.

5. An ornament module according to claim 2, characterized in that it is provided with display control unit.

6. An ornament module according to claim 1, characterized in that said ornament unit includes two or more mechanical movement units connected actively with said ornament unit respectively.

7. An ornament module according to claim 1, characterized in that said mechanical movement unit with a cylinder-type structure, includes a hollow columnar shell, a hollow base set within the shell cavity, as well as a transmission screw connecting fixedly to the top of said shell cavity and extending into the hollow space of said base along the axial direction of said columnar shell, said ornament unit is provided on the top of said columnar shell, said motivity unit is a linear motor set fixedly within the hollow space of said base and screwed to said transmission screw, said motivity control unit is a frequency converter.

8. An ornament module according to claim 1, characterized in that said mechanical movement unit with a cylinder-type structure, includes a hollow columnar shell, a hollow base set within the shell cavity, as well as a transmission thread insert connecting fixedly to the top of said shell cavity and extending into the hollow space of said base along the axial direction of said columnar shell, said ornament unit is provided on the top of said columnar shell, said motivity unit is a transmission motor set fixedly within the hollow space of said base, said transmission motor has a transmission screw screwed to said transmission thread insert, said motivity control unit is a frequency converter.

9. An ornament module according to claim 1, characterized in that said mechanical movement unit with a cylinder-type structure, includes a hollow columnar shell, a hollow base set within the shell cavity, as well as a pressure uplift device set within the hollow space of said base, the top of said pressure uplift device is against the top of said shell cavity closely, the bottom of said pressure uplift device is against the bottom of the hollow space of said base, said ornament unit is provided on the top of said columnar shell, said motivity unit is a pneumatic engine set at the external of mechanical movement unit for supplying said pressure uplift device, said motivity control unit is a electronically controlled pneumatic valve.

10. An ornament device comprises two or more ornament modules according to claim 7, a master computer and a distributed control unit; said distributed control unit is connected to the motivity control unit of each ornament module on one end and connected to the master computer on the other end.

11. An ornament device comprises two or more ornament modules according to claim 8, a master computer and a distributed control unit; said distributed control unit is connected to the motivity control unit of each ornament module on one end and connected to the master computer on the other end.

12. An ornament device comprises two or more ornament modules according to claim 9, a master computer and a distributed control unit; said distributed control unit is connected to the motivity control unit of each ornament module on one end and connected to the master computer on the other end.

13. An ornament device according to claim 11, characterized in that which includes data distributor, said data distributor is connected to each distributed control unit on one end and connected to the master computer on the other end.

14. An ornament device according to claim 13, characterized in that said distributed control unit is a multi-path variable frequency signal generator.
